(19) United States
(12) Patent Application Publication
(10) Pub. No.: US 2026/0235935 A1
(43) Pub. Date: Aug. 13, 2026

(54) CAMERA MODULE

(71) Applicant: SAMSUNG ELECTRO-MECHANICS CO., LTD., Suwon-si (KR)

(72) Inventors: Jae Sung OH, Suwon-si (KR); Min Jeong KANG, Suwon-si (KR)

(73) Assignee: SAMSUNG ELECTRO-MECHANICS CO., LTD., Suwon-si (KR)

(21) Appl. No.: 19/245,531

(22) Filed: Jun. 23, 2025

(30) Foreign Application Priority Data
Feb. 10, 2025 (KR) 10-2025-0016692

(51) Int. Cl. G03B 17/12

(52) U.S. Cl. CPC G03B 17/12

(57) ABSTRACT

A camera module is provided. The camera module includes a housing; a carrier, disposed in the housing, and configured to move in an optical axis direction with respect to the housing; a first damper fixed to the carrier; and a first frame, disposed in the carrier, and configured to move in a direction perpendicular to an optical axis direction with respect to the carrier, and having a concave portion formed on a surface that faces the carrier, wherein the first damper protrudes toward the first frame in the optical axis direction, and at least a portion of the concave portion is disposed to face the first damper in the direction perpendicular to the optical axis.

### CROSS-REFERENCE TO RELATED APPLICATIONS

This application claims the benefit under 35 USC §119(a) of Korean Patent Application No. 10-2025-0016692 filed on February 10, 2025, in the Korean Intellectual Property Office, the entire disclosure of which is incorporated herein by reference for all purposes.

### BACKGROUND

### 1. Field

The following description relates to a camera module.

### 2. Description of Related Art

Recently, cameras have been implemented in portable electronic devices such as, but not limited to, smartphones, tablet personal computers (PCs), and laptops.

Most camera modules implemented in portable electronic devices have various operations such as autofocusing (AF) and optical imaging stabilization (OIS).

As camera modules have various operations, the number of components mounted in the camera module has increased, and the sizes and weights of camera modules has also increased.

In particular, due to an increase in the weight due to an increase in a size of the lens within the camera module, there is a problem in that an amount of impact increases when components collide, causing a joint when performing the autofocusing or optical imaging stabilization operations, or increasing deformation or damage when subjected to external impacts.

Accordingly, there is a need for a camera module having a damper structure that reduces the occurrence of a joint by improving a buffering effect during driving operations to perform the autofocusing or optical imaging stabilization operations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing; a carrier, disposed in the housing, and configured to move in an optical axis direction with respect to the housing; a first damper fixed to the carrier; and a first frame, disposed in the carrier, and configured to move in a direction perpendicular to an optical axis with respect to the carrier, and having a concave portion formed on a surface that faces the carrier, wherein the first damper protrudes toward the first frame in the optical axis direction, and wherein at least a portion of the concave portion faces the first damper in the direction perpendicular to the optical axis.

The camera module may include a second frame disposed between the carrier and the first frame, and configured to move in the direction perpendicular to the optical axis, wherein the second frame may include a first through-hole through which the first damper penetrates.

The first damper may include a surface that faces the concave portion in the optical axis direction.

Based on the optical axis direction, a minimum gap between the first frame and the first damper may be greater than a minimum gap between the first frame and the second frame.

Based on the optical axis direction, a minimum gap between the first frame and the first damper may be greater than a minimum gap between the second frame and the carrier.

Based on the optical axis direction, a minimum gap between the first frame and the first damper may be less than a sum of a minimum gap between the first frame and the second frame and a minimum gap between the second frame and the carrier.

Based on the direction perpendicular to the optical axis, a minimum gap between the first frame and the first damper may be greater than or equal to a maximum movable distance of the first frame in the direction perpendicular to the optical axis, and a minimum gap between the second frame and the first damper may be greater than or equal to a maximum movable distance of the second frame in the direction perpendicular to the optical axis.

The first damper may include an elastic material.

The first damper may include a core therein.

The core may be formed of a non-magnetic metal material.

The first damper may include a second through-hole that penetrates in the direction perpendicular to the optical axis.

The first damper may include a core therein.

The first damper may be disposed in at least one of corner regions of the carrier.

The first damper may be provided in plural, and at least a pair of the plurality of first dampers are disposed in the direction perpendicular to the optical axis.

The camera module may further include a stopper coupled to the carrier to cover the first frame; and a case coupled to the housing to cover the stopper, wherein the stopper may include a second damper that faces the case in the optical axis direction.

In a general aspect, a camera module includes a housing unit; a carrier, accommodated in the housing unit, and having a first damper disposed therein; a first frame accommodated in the carrier, and coupled to a lens barrel; and a second frame disposed between the carrier and the first frame, wherein the first damper penetrates the second frame and a portion of the first damper is accommodated in the first frame, and wherein, based on an optical axis direction, a minimum gap between the first frame and the first damper is greater than a minimum gap between the first frame and the second frame and a minimum gap between the second frame and the carrier, respectively, and is less than a sum of the minimum gap between the first frame and the second frame and the minimum gap between the second frame and the carrier.

The carrier may include a first surface that faces the first frame and a second surface opposite the first surface, and the first damper may protrude beyond the second surface of the carrier.

The first damper may be fixed to the carrier by a fixed member comprised in the carrier.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view of an example camera module, in accordance with one or more embodiments.

FIG. 3 illustrates an exploded perspective view of a coupling relationship between a first frame, a second frame, and a carrier.

FIG. 4 illustrates a cross-sectional view taken along line I-I' of FIG. 1;

FIG. 5 is an enlarged view of region A of FIG. 4.

FIG. 6 is a diagram schematically illustrating an example in which impacts in an optical axis direction are applied to the camera module of FIG. 4.

FIG. 7 is a diagram schematically illustrating an example in which impacts in a direction perpendicular to an optical axis are applied to the camera module of FIG. 4.

FIG. 8 illustrates a plan view of a carrier in which a first damper is disposed, in accordance with one or more embodiments.

FIG. 9 to FIG. 11 are modified examples of the first damper of FIG. 5.

FIG. 12 and FIG. 13 are modified examples of the carrier of FIG. 8.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” "connected to," "coupled to," or "joined to" another component, element, or layer, it may be directly (e.g., in contact with the other component, element, or layer) “on,” "connected to," "coupled to," or "joined to" the other component element, or layer, or there may reasonably be one or more other components elements, or layers intervening therebetween. When a component or element is described as "directly on", "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a camera module in which a size of a joint that may occur during driving operations to perform autofocusing or optical imaging stabilization operations may be minimized.

One or more examples may provide a camera module that can effectively alleviate impacts applied in an optical axis direction or in a direction perpendicular to an optical axis.

A camera module 1000, in accordance with one or more embodiments, may be used to take pictures and videos of an external subject.

A camera module 1000, in accordance with one or more embodiments, may be applied to a portable electronic device such as a smartphone, as only an example.

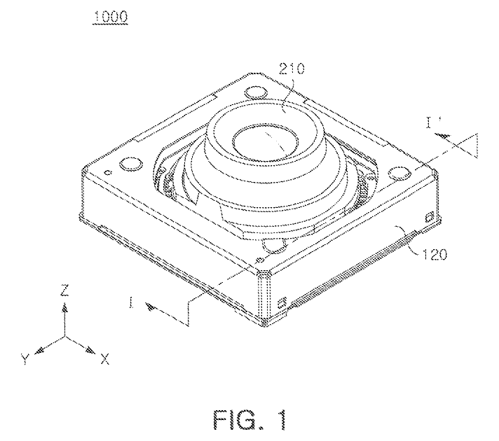

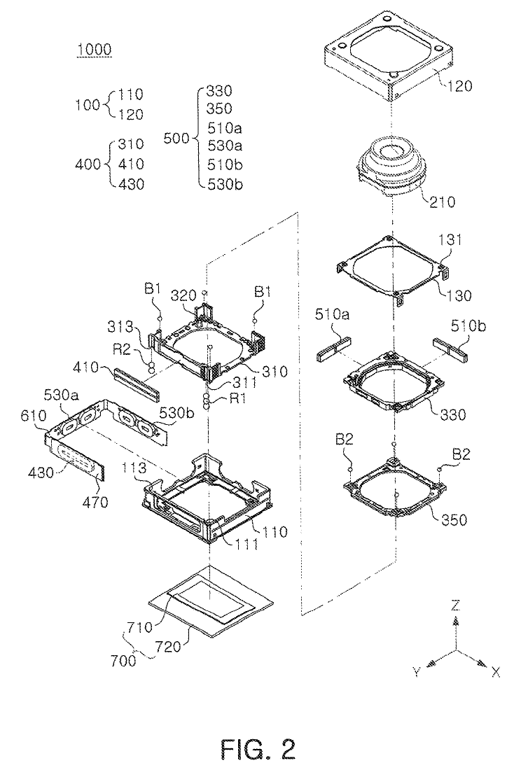

FIG. 1 is a perspective view of an example camera module, in accordance with one or more embodiments. FIG. 2 is an exploded perspective view of an example camera module, in accordance with one or more embodiments.

Referring to FIGS. 1 and 2, the camera module 1000, in accordance with one or more embodiments, may include a lens barrel 210, a lens driving device that moves the lens barrel 210, an image sensor module 700 that converts light incident through the lens barrel 210 into an electric signal, and a housing unit 100 that accommodates the lens barrel 210 and the lens driving device.

The housing unit 100 may include a housing 110 and a case 120.

The lens barrel 210 may have a hollow cylindrical shape, and a plurality of lenses may be disposed inside the lens barrel 210.

A plurality of lenses may be mounted inside the lens barrel 210 in an optical axis (Z-axis) direction. The plurality of lenses may be disposed in a desired number, and each lens may have the same or different optical characteristics.

The lens driving device may be a device that moves the lens barrel 210.

The lens driving device may include a focus adjustment portion 400 and a shake correction unit 500. The focus adjustment unit 400 may adjust a focus of the camera by moving the lens barrel 210 in a direction of an optical axis (Z-axis), and the shake correction unit 500 may correct shaking during image capturing by moving the lens barrel 210 in a direction perpendicular to the optical axis (Z-axis) (X-axis and Y-axis directions).

The image sensor module 700 may be a device that converts light incident through the lens barrel 210 into an electrical signal.

The image sensor module 700 may include an image sensor 710 and a sensor substrate 720 on which the image sensor 710 is mounted.

The image sensor 710 may convert light incident through the lens barrel 210 into an electrical signal. In a non-limited example, the image sensor 710 may be a Charge Coupled Device (CCD) or a Complementary Metal-Oxide Semiconductor (CMOS).

The electrical signal converted through the image sensor 710 may be output as an image or video through a display device of the portable electronic device.

The image sensor 710 may be electrically connected to a sensor substrate 720. In an example, the sensor substrate 720 may be a printed circuit board (PCB).

A lens barrel 210 and a lens driving device may be accommodated in the housing 110. In an embodiment, the housing 110 may have an internal space, and a lens barrel 210 and a lens driving device may be accommodated in the internal space of the housing 110.

Additionally, an image sensor module 700 may be disposed in a lower portion of the housing 110. In an embodiment, a sensor substrate 720 may be coupled to a bottom surface of the housing 119, and the image sensor 710 may be exposed to the internal space of the housing 110 while the sensor substrate 720 is coupled to the housing 110.

In an example, a main substrate 610 that provides a driving signal to a focus adjustment unit 400 and a shake correction unit 500 may be disposed on a side surface of the housing 110. In an embodiment, the main substrate 610 may be disposed to surround the side surface of the housing 110.

A driving coil and a position sensor that form the focus adjustment unit 400 and the shake correction unit 500 may be disposed on the main substrate 610.

The housing 110 may include an opening on the side surface, and the driving coil and position sensor may be disposed in the opening and exposed to an internal space of the housing 110.

The case 120 may be coupled to cover the internal space of the housing 110 and may protect components accommodated in the internal space.

Additionally, the case 120 may also have an operation of shielding electromagnetic waves. Accordingly, the case 120 may be formed of a metal material, and may be grounded to a ground pad included in the sensor substrate 720.

The camera module 1000, in accordance with one or more embodiments, may further include a stopper 130 to absorb impacts transmitted to internal components due to external impacts, or the like, and to prevent a first frame 330 and the second frame 350 from being separated from a carrier 310.

The stopper 130 may be coupled to the carrier 310 to cover at least a portion of an upper surface of the first frame 330. The stopper 130 may include a main body disposed to cover the upper surface of the first frame 330, and a fastening portion that extends in the optical axis (Z-axis) direction from each corner portion of the main body. The stopper 130 may be coupled to the carrier 310 through a fastening portion. In an embodiment, the fastening portion may be inserted into a groove formed in the carrier 310 and fixed thereto.

The stopper 130 of an embodiment may include a second damper 131 to increase a buffering effect between the case 120 and the first frame 330. The second damper 131 may be disposed on the stopper 130 to face the case 120 in the optical axis (Z-axis) direction. The second damper 131 may be disposed at each corner of the main body of the stopper 130, and may protrude upwardly and outwardly of the stopper 130, thereby alleviating impacts in the optical axis (Z-axis) direction between the case 120 and the stopper 130, and the stopper 130 and the first frame 330.

In an embodiment, the second damper 131 may be disposed to penetrate the stopper 130. For example, the second damper 131 may be inserted into a hole formed in the main body of the stopper 130 in the optical axis (Z-axis) direction. However, an embodiment thereof is not limited thereto, and the second damper 131 may be coupled to the stopper 130 through an insert injection process, or the second damper 131 and the stopper 130 may be manufactured separately, and then the second damper 131 may be bonded to the stopper 130 using an adhesive, or the like.

In an example, the camera module 1000 may include a first damper 320 disposed in the carrier 310 to reduce a size of a joint that may occur during driving for autofocusing or optical imaging stabilization operations to effectively buffer impacts applied in an optical axis direction or in a direction perpendicular to an optical axis.

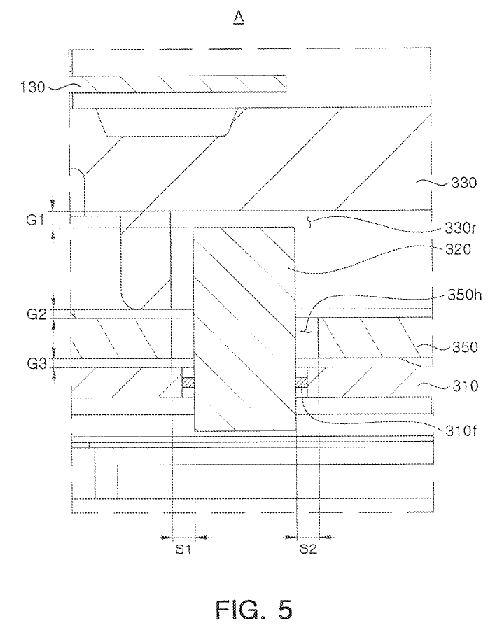

In an embodiment, the first damper 320 may have the same shape as a pillar having a length in the optical axis direction, and may be fixed to the carrier 310 and protrude toward the first frame 330. In an example, referring to FIG. 5, the first damper 320 may be fixed to the carrier 310 by a fixed member 310f included in the carrier 310. In an embodiment, the fixed member 310f may be formed integrally with the carrier 310 by insert injection, and the first damper 320 may be inserted and fixed into a hole formed in the fixed member 310f. However, the one or more examples are not limited thereto.

Additionally, the first damper 320 may penetrate a second frame 350 between the carrier 310 and the first frame 330, and at least a portion thereof may be accommodated in a concave portion 330r formed in the frame 330, thereby alleviating impacts caused by a collision in the optical axis (Z-axis) direction between the first frame 330, the second frame 350, and the carrier 310. Additionally, the first damper 320 may be buffered in a direction perpendicular to the optical axis (Z-axis) with respect to a side surface of the concave portion 330r of the first frame 330 and a side surface of a through-hole 350h of the second frame 350.

Additionally, referring to FIG. 5, in the camera module 1000, a minimum gap G1 between the first damper 320 and the first frame 330 may be determined by a relationship with a minimum gap G2 between the first frame 330 and the second frame 350 and a minimum gap G3 between the second frame 350 and the carrier 310. A detailed description thereof will be described later with reference to FIG. 5.

Hereinafter, with reference to FIG. 2, a focus adjustment unit 400 among lens driving devices of the camera module 1000, in accordance with one or more embodiments, will be described.

According to an embodiment, the focus adjustment unit 400 may include a carrier 310 that accommodates a lens barrel 210, and a focus adjustment driving unit that generates a driving force so that the lens barrel 210 and the carrier 310 may move in an optical axis (Z-axis) direction.

The carrier 310 may accommodate a lens barrel 210, and may be accommodated in an internal space of the housing 110.

The carrier 310 may be moved in the optical axis (Z-axis) direction with respect to the housing 110 together with the lens barrel 210 by a driving force generated by a focus adjustment driving unit.

The focus adjustment driving unit may include a focus adjustment magnet 410 and a focus adjustment coil 430.

A focus adjustment magnet 410 may be disposed on one side surface of the carrier 310, and a focus adjustment coil 430 may be disposed on one side surface of the housing 110 through the main substrate 610.

In an example, the focus adjustment coil 430 may be disposed on one side surface of the housing 110 facing one side surface of the carrier 310 on which the focus adjustment magnet 410 is disposed.

The focus adjustment magnet 410 and the focus adjustment coil 430 may face each other in one direction perpendicular to the optical axis (Z-axis), and the focus adjustment magnet 410 and the focus adjustment coil 430 may face each other directly through an opening of the housing 110.

When power is applied to the focus adjustment coil 430, the carrier 310 may be moved in the optical axis (Z-axis) direction by an electromagnetic force between the focus adjustment magnet 410 and the focus adjustment coil 430.

In an embodiment, the focus adjustment magnet 410 may be moved in the optical axis (Z-axis) direction together with the carrier 310, and the focus adjustment coil 430 may be fixed to the housing 110. However, an embodiment thereof is not limited thereto, and positions of the focus adjustment magnet 410 and the focus adjustment coil 430 may be interchangeable.

When the carrier 310 is moved, rolling members R1 and R2 may be disposed between the carrier 310 and the housing 110 to reduce friction between the carrier 310 and the housing 110. In an example, the rolling members R1 and R2 may be a plurality of ball members.

The rolling members R1 and R2 may be respectively disposed on both sides of the focus adjustment magnet 410.

In an embodiment, the number of rolling members R1 disposed on one side of the focus adjustment magnet 410 may be greater than the number of rolling members R2 disposed on the other side thereof. In this example, the rolling member R1 disposed on one side of the focus adjustment magnet 410 may operate as a main guide, and the rolling member R2 disposed on the other side of the focus adjustment magnet 410 may operate as an auxiliary guide.

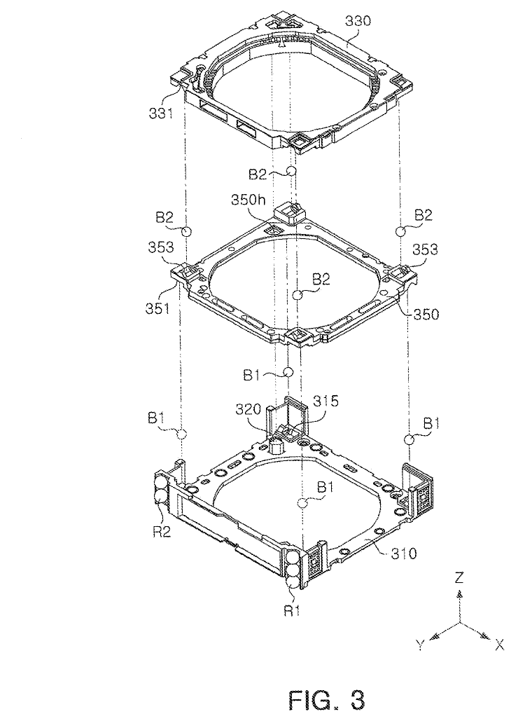

Referring to FIGS. 2 and 3, the carrier 310 may include first guide grooves 311 and 313 in which portions of the rolling members R1 and R2 are respectively accommodated on both sides of the focus adjustment magnet 410.

In an embodiment, the first guide grooves 311 and 313 may extend in the optical axis (Z-axis) direction, the rolling member R1 disposed on one side of the focus adjustment magnet 410 may contact the first guide groove 311 at two points, and the rolling member R2 may contact the first guide groove 313 disposed on the other side of the focus adjustment magnet 410 at one point.

In the housing 110, second guide grooves 111 and 113 may be formed to face the first guide grooves 311 and 313 respectively. Other portions of the rolling members R1 and R2 may be accommodated in the second guide grooves 111 and 113.

In an embodiment, the second guide grooves 111 and 113 may extend in the optical axis (Z-axis) direction, similar to the first guide grooves 311 and 313. Additionally, the rolling member R1 disposed on one side of the focus adjustment magnet 410 may contact the second guide groove 111 at two points, and the rolling member R2 may also contact the second guide groove 113 disposed on the other side of the focus adjustment magnet 410 at two points.

An outer surface of the main substrate 610 may have a first yoke 470 disposed thereon. In an embodiment, the first yoke 470 may correspond to a magnetic material. A focus adjustment coil 430 may be disposed on one surface of the main substrate 610, and a first yoke 470 may be disposed on the other surface thereof.

The first yoke 470 may face the focus adjustment magnet 410 with the focus adjustment coil 430 interposed therebetween, so that the first yoke 470 and the focus adjustment magnet 410 may face each other in a direction perpendicular to the optical axis (Z-axis).

A magnetic force may be applied between the first yoke 470 and the focus adjustment magnet 410 in a direction facing each other, that is, in a direction perpendicular to the optical axis (Z-axis).

Accordingly, the carrier 310 may be supported in close contact with the housing 110 in a direction perpendicular to the optical axis (Z-axis), and the rolling members R1 and R2 may be maintained in contact with the carrier 310 and the housing 110.

Additionally, the first yoke 470 may also focus a magnetic force generated by the focus adjustment magnet 410, by forming a magnetic circuit with the focus adjustment magnet 410.

According to an embodiment, the focus adjustment portion 400 may use a closed loop control method which detects and feedbacks a position of the lens barrel 210. Accordingly, the focus adjustment portion 400 may include a position sensor that detects the position of the lens barrel 210 in the optical axis (Z-axis) direction.

The position sensor may be disposed on one side of the housing 110 through the main substrate 610 together with the focus adjustment coil 430. Although not illustrated, the position sensor may be disposed on the inside or the outside of the focus adjustment coil 430. The position sensor may be a magnetic sensor, for example, a Hall sensor. However, an embodiment thereof is not limited thereto, and the position sensor may be implemented as another type of sensor, such as a gyroscope or an accelerometer.

FIG. 3 is an exploded perspective view illustrating a coupling relationship between a first frame 330, a second frame 350, and a carrier 310.

Referring to FIGS. 2 and 3, a shake correction unit 500 among the lens driving devices of the camera module 1000, in accordance with one or more embodiments, will be described.

The shake correction unit 500 may compensate for shaking by providing relative displacement corresponding to the shaking to the lens barrel 210, when shaking occurs due to user hand-shaking, or the like, when shooting a video, or the like.

According to an embodiment, the shake correction unit 500 may include a first frame 330 and a second frame 350, that guides the movement of the lens barrel 210, and a shake correction driving unit that generates a driving force in directions (X-axis and Y-axis directions) perpendicular to an optical axis (Z-axis) with respect to the first frame 330 and the second frame 350.

The first frame 330 and the second frame 350 may be accommodated in the carrier 310. In an embodiment, the second frame 350 and the first frame 330 may be accommodated in the carrier 310 in sequence in the optical axis (Z-axis) direction.

Additionally, a lens barrel 210 may be inserted into, and fixed in, the first frame 330.

The first frame 330 and the second frame 350 may be moved in the directions (X-axis and Y-axis directions) perpendicular to the optical axis (Z-axis) with respect to the carrier 310, together with the lens barrel 210 by a driving force generated by the shake correction driving unit.

In an embodiment, one of the first frame 330 and the second frame 350 may be moved in a first axis (X-axis) direction perpendicular to the optical axis (Z-axis), and the other thereof may be moved in a second axis (Y-axis) direction perpendicular to both the optical axis (Z-axis) and the first axis (X-axis).

The shake correction driving unit may include a shake correction magnet and a shake correction coil.

In an embodiment, the shake correction driving unit may include a first magnet 510a and a first coil 530a that generates a driving force in a first axis (X-axis) direction, and a second magnet 510b and a second coil 530b that generates a driving force in a second axis (Y-axis) direction.

In an embodiment, the first magnet 510a and the second magnet 510b may be divided and disposed on two mutually perpendicular side surfaces of the first frame 330. Therefore, the first frame 330 may be moved in the first axis (X-axis) direction and the second axis (Y-axis) direction.

In an example, the first coil 530a and the second coil 530b may be disposed in the housing 110 through a main substrate 610. In an example, the first coil 530a and the second coil 530b may be disposed on two side surfaces of the housing 110 facing each other with the two mutually perpendicular side surfaces of the first frame 330 on which the first magnet 510a and the second magnet 510b are disposed.

The shake correction magnet and the shake correction coil may generate a driving force in directions facing each other.

Accordingly, the first magnet 510a and the first coil 530a may be disposed to face each other in the first axis (X-axis) direction, and the second magnet 510b and the second coil 530b may be disposed to face each other in the second axis (Y-axis) direction.

In an example, the first magnet 510a and the second magnet 510b may be moved in the directions (X-axis and Y-axis directions) perpendicular to the optical axis (Z-axis) together with the first frame 330, and the first coil 530a and the second coil 530b may be fixed to the housing 110. However, an embodiment thereof is not limited thereto, and positions of the first magnet 510a and the first coil 530a and positions of the second magnet 510b and the second coil 530b may be interchangeable.

Referring to FIGS. 2 and 3, a plurality of ball members B1 and B2 may be disposed between the first frame 330 and the second frame 350, and between the second frame 350 and the carrier 310.

The plurality of ball members B1 and B2 may guide a movement of the first frame 330 or the second frame 350 and maintain a gap between the first frame 330 and the second frame 350, and between the second frame 350 and the carrier 310.

The plurality of ball members may include a first ball member B1 disposed between the second frame 350 and the carrier 310. In an example, the first ball member B1 may include three or more ball members.

The first ball member B1 may guide a movement of the second frame 350 in the first axis (X-axis) direction.

In an embodiment, since the first frame 330 is supported by the second frame 350, and the lens barrel 210 is fixed to the first frame 330, when the second frame 350 moves in the first axis (X-axis) direction, the lens barrel 210 and the first frame 330 may move in the first axis (X-axis) direction together with the second frame 350.

The second frame 350 may include a third guide groove 351 in which a portion of the first ball member B1 is accommodated on a surface facing the carrier 310 in the optical axis (Z-axis) direction.

Additionally, a fourth guide groove 315 in which the other portion of the first ball member B1 is accommodated may be formed in the carrier 310 on a surface facing the second frame 350 in the optical axis (Z-axis) direction. The fourth guide groove 315 may face the third guide groove 351 in the optical axis (Z-axis) direction.

The third guide groove 351 and the fourth guide groove 315 may extend in the first axis (X-axis) direction. Therefore, when a driving force in the first axis (X-axis) direction is generated, the first ball member B1 may roll along the third guide groove 351 and the fourth guide groove 315 in the first axis (X-axis) direction, and the movement thereof in the second axis (Y-axis) may be restricted.

The plurality of ball members may include a second ball member B2 disposed between the first frame 330 and the second frame 350. For example, the second ball member B2 may include three or more ball members.

The second ball member B2 may guide the movement of the first frame 330 in the second axis (Y-axis) direction.

In an embodiment, since the lens barrel 210 is fixed to the first frame 330, when the first frame 330 moves in the second axis (Y-axis) direction, the lens barrel 210 may move in the second axis (Y-axis) direction together with the first frame 330.

The first frame 330 may include a fifth guide groove 331 in which a portion of the second ball member B2 is accommodated on a surface facing the second frame 350 in the optical axis (Z-axis) direction.

Additionally, a sixth guide groove 353, in which the other portion of the second ball member B2 is accommodated, may be formed in the second frame 350 on a surface facing the first frame 330 in the optical axis (Z-axis) direction. The sixth guide groove 353 may face the fifth guide groove 331 in the optical axis (Z-axis) direction.

The fifth guide groove 331 and the sixth guide groove 353 may extend in the second axis (Y-axis) direction.

Therefore, when a driving force in the second axis (Y-axis) direction is generated, the second ball member B2 may roll along the fifth guide groove 331 and the sixth guide groove 353 in the second axis (Y-axis) direction, and a movement thereof in the first axis (X-axis) direction may be restricted.

In an example, in another embodiment, the second frame 350 may be omitted, and the first frame 330 may be accommodated in the carrier 310 while being fixed to the lens barrel 210.

In this example, the plurality of ball members disposed between the first frame 330 and the carrier 310 may roll in the first-axis (X-axis) direction when a driving force in the first-axis (X-axis) direction is generated, and may roll in the second-axis (Y-axis) direction when a driving force in the second-axis (Y-axis) direction is generated.

Accordingly, the guide groove formed on the surface of the first frame 350 and the carrier 310 facing each other in the optical axis (Z-axis) direction may have a shape that does not limit a movement direction of the plurality of ball members on a plane perpendicular to the optical axis (Z-axis).

Although not shown, a plurality of yokes may be disposed in the carrier 310 to face the first magnet 510a and the second magnet 510b disposed in the first frame 330 in the optical axis (Z-axis) direction, respectively. In an embodiment, the plurality of yokes may correspond to a magnetic body.

A magnetic attraction may be applied between the plurality of yokes and the first magnet 510a and the second magnet 510b in a direction facing each other, that is, in an optical axis (Z-axis) direction. Therefore, the first frame 330 and the second frame 350 may be pressed against the carrier 310 in the optical axis (Z-axis) direction, and the first ball member B1 may maintain a state of contact with the second frame 350 and the carrier 310, and the second ball member B2 may maintain a state of contact with the first frame 330 and the second frame 350.

According to an embodiment, the shake correction unit 500 may use a closed-loop control method which detects and feeds back a position of the lens barrel 210. Accordingly, the shake correction unit 500 may include a plurality of position sensors. The plurality of position sensors may detect the positions of the lens barrel 210 in the first axis (X-axis) direction and the second axis (Y-axis) direction.

Although not shown, a plurality of position sensors may be disposed on one side of the housing 110 through the main substrate 610 together with a first coil 530a and a second coil 530b, respectively. In an embodiment, the plurality of position sensors may be disposed on the inner or outer side of the first coil 530a and the second coil 530b.

The plurality of position sensors may be magnetic sensors, for example, Hall sensors, but is the one or more examples are not limited thereto, and the plurality of position sensors may also be implemented as other types of sensors, such as gyroscopes or accelerometers, as only examples.

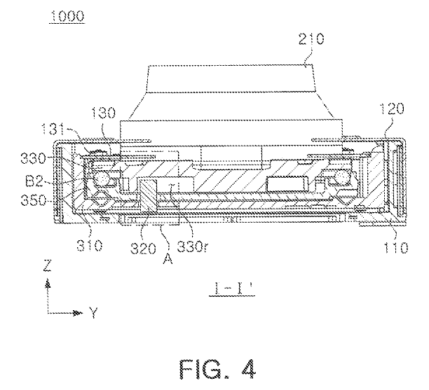

FIG. 4 is a cross-sectional view taken along line I-I' of FIG. 1. FIG. 5 is an enlarged view of portion A of FIG. 4.

Referring to FIGS. 4 and 5, the camera module 1000 according to an embodiment may include a first damper 320 fixed to a carrier 310. The first damper 320 is configured to reduce a size of a joint that may occur during driving to perform an autofocusing operation or an optical imaging stabilization operation, and effectively buffer impacts applied in an optical axis (Z-axis) direction or in a direction perpendicular to the optical axis (Z-axis).

The first damper 320 of the present embodiment may be disposed to protrude toward the first frame 330 in the optical axis (Z-axis) direction. The first damper 320 may have a columnar configuration extending in the optical axis (Z-axis) direction.

Additionally, the first damper 320 may include an elastic material. The first damper 320 may include an elastic material or a soft material with a high buffering effect, such as rubber or foam material. However, the one or more examples are not limited thereto.

The first damper 320 may be disposed to be fixed to a carrier 310. The first damper 320 may be fixed to the carrier 310 by, for example, being inserted into a hole of a fixed member 310f formed integrally with the carrier 310 through insert injection in the optical axis (Z-axis) direction. However, is the one or more examples are not limited thereto, and the first damper 320 may also be disposed in a form directly fixed to a hole formed in the carrier 310.

The first damper 320 may include one surface facing the first frame 330 in an optical axis (Z-axis) direction and the other surface facing the housing 110 in the optical axis (Z-axis) direction. Through the structure, the first damper 320 may reduce a joint when driving is done to perform an autofocusing operation. Additionally, when the carrier 310 moves beyond the limit range in the optical axis (Z-axis) direction due to an external impact, the first damper 320 may alleviate the impact by contacting the first frame 330 or housing 110.

Additionally, the first damper 320 may include a side surface that faces the first frame 330 and the second frame 350 in a direction perpendicular to the optical axis (Z-axis). Through the structure, the first damper 320 may reduce a joint when driving is done to perform an optical imaging stabilization operation. Additionally, when the carrier 310 moves beyond the limit range in the direction perpendicular to the optical axis (Z-axis) due to an external impact, the first damper 320 may alleviate the impact by contacting the first frame 330 or the second frame 350.

Referring to FIGS. 4 and 5, the first frame 330 of the present embodiment may include a concave portion 330r that is formed on a surface facing the carrier 310. The concave portion 330r corresponds to a lower portion of the first frame 330, that is, a space formed in a region facing the second frame 350 and the carrier 310.

At least a portion of the concave portion 330r may face the first damper 320 in a direction perpendicular to an optical axis (Z-axis). Through such a structure, buffering between the first damper 320 and the concave portion 330r may be performed in the direction perpendicular to the optical axis (Z-axis).

Additionally, the first damper 320 may include a surface that faces the concave portion 330r in the optical axis (Z-axis) direction. Through such a structure, buffering between the first damper 320 and the concave portion 330r may be performed in the direction perpendicular to the optical axis (Z-axis).

The second frame 350 of the present embodiment may be disposed between the carrier 310 and the first frame 330. The second frame 350 may include a first through-hole 350h formed in the optical axis (Z-axis) direction. The first damper 320 of the present embodiment may be disposed to penetrate through the first through-hole 350h.

Referring to FIG. 5, based on the optical axis (Z-axis) direction, a minimum gap G1 between the first frame 330 and the first damper 320 may be greater than a minimum gap G2 between the first frame 330 and the second frame 350. Additionally, based on the optical axis (Z-axis) direction, the minimum gap G1 between the first frame 330 and the first damper 320 may be greater than a minimum gap G3 between the second frame 350 and the carrier 310.

Additionally, based on the optical axis (Z-axis) direction, the minimum gap G1 between the first frame 330 and the first damper 320 may be less than the sum (G2+G3) of the minimum gap G2 between the first frame 330 and the second frame 350 and the minimum gap G3 between the second frame 350 and the carrier 310. In an example, the minimum gap may mean the smallest gap among the optical axis (Z-axis) direction gaps between each component based on a state in which no impact occurs to the camera module 1000. Through such a structure, when an external impact occurs in the optical axis (Z-axis) direction of the camera module 1000, a full-scale collision between the three components, the carrier 310, the second frame 350, and the first frame 330, may be prevented, thereby alleviating the occurrence of noise and/or cracks.

Through such a structure, when an external impact occurs in the optical axis (Z-axis) direction of the camera module 1000, a full-scale collision between the three components, the carrier 310, the second frame 350, and the first frame 330, may be prevented, thereby alleviating the occurrence of noise and/or cracks.

Specifically, the camera module 1000 of the present embodiment may cause a collision between the first frame 330 and the first damper 320 before the second frame 350 and the first frame 330 collide, through the first damper 320 disposed to have the above-described gap, after the carrier 310 and the second frame 350 collide. Therefore, the carrier 310, the second frame 350, and the first frame 330 may be prevented from colliding simultaneously or sequentially, thereby reducing the risk of the occurrence of noise and cracks.

In an example, referring to FIG. 5, a cross-sectional area of the first damper 320 based on the cross-section in the direction perpendicular to the optical axis (Z-axis) may be narrower than a cross-sectional area of the first through-hole 350h. That is, the first damper 320 may be disposed to have constant gaps S1 and S2 with the second frame 350 within the first through-hole 350h.

In the camera module 1000 of the present embodiment, the minimum gap S1 between the first frame 330 and the first damper 320 in the direction perpendicular to the optical axis (Z-axis) may be greater than or equal to a maximum movable distance in the direction perpendicular to the optical axis (Z-axis) of the first frame 330. Additionally, the minimum gaps S1 and S2 between the second frame 350 and the first damper 320 may be greater than or equal to a maximum movable distance in the direction perpendicular to the optical axis (Z-axis) of the second frame 350. Through such a structure, when the first frame 330 and the second frame 350 are driven for optical imaging stabilization, each of the first frame 330 and the second frame 350 may be driven without contacting the first damper 320 up to the maximum movable distance (stroke). Additionally, when displacement exceeding the maximum movable distance (stroke) of each of the first frame 330 and the second frame 350 occurs in the direction perpendicular to the optical axis (Z-axis), the first damper 320 may collide with each of the first frame 330 and/or the second frame 350 to alleviate the impact.

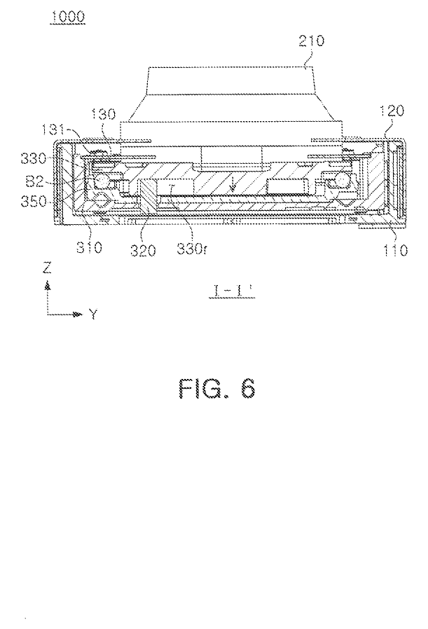

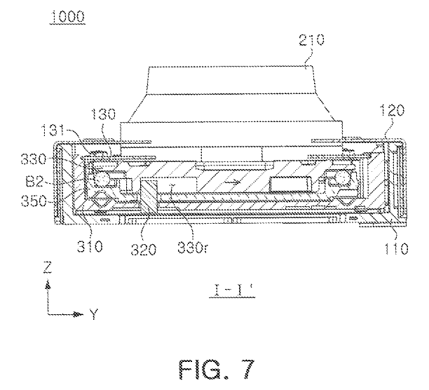

FIG. 6 is a drawing schematically illustrating an example in which impacts in an optical axis (Z-axis) direction are applied to the camera module 1000 of FIG. 4. FIG. 7 is a drawing schematically illustrating an example in which impacts in a direction perpendicular to an optical axis (Z-axis) are applied to the camera module 1000 of FIG. 4.

Referring to FIG. 6, for example, when impacts occur on a lower surface of the camera module 1000 in the optical axis (Z-axis) direction, the first frame 330 and the second frame 350 may move downwardly, respectively, and a collision between components may occur. That is, a collision between the carrier 310 and the second frame 350, and a collision between the first frame 330 and the second frame 350 may occur simultaneously or sequentially.

Referring to FIGS. 5 and 6, before impacts occur, based on the optical axis (Z-axis) direction, a minimum gap G1 between the first frame 330 and the first damper 320 may be less than the sum (G2+G3) of a minimum gap G2 between the first frame 330 and the second frame 350, and a minimum gap G3 between the second frame 350 and the carrier 310. Therefore, even if impacts occur in the optical axis (Z-axis) direction, as illustrated in FIG. 6, the impact may be alleviated by the first frame 330, first contacting the first damper 320 before colliding with the second frame 350.

Meanwhile, the carrier 310 of the present embodiment includes one surface that faces the first frame 330 and the other surface opposite the one surface, and the first damper 320 may be disposed to protrude further than the other surface of the carrier 310. Through this structure, the first damper 320 may also have an operation of alleviating impact with a configuration that can be disposed below the carrier 310, for example, the sensor substrate 720 of FIG. 2.

Referring to FIG. 7, for example, when impacts occur on a left surface of the camera module 1000 in a direction perpendicular to the optical axis (Z-axis), the first frame 330 and/or the second frame 350 may move to the right and collide with the first damper 320. The impact of the first frame 330 and/or the second frame 350 may be alleviated by first colliding with the first damper 320 before colliding with other components such as a carrier 310, or the like.

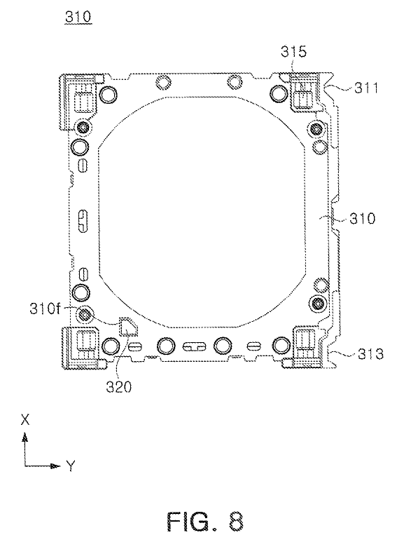

FIG. 8 illustrates a plan view of a carrier 310 on which a first damper 320 of the present embodiment is disposed.

Referring to FIGS. 5 and 8, the first damper 320 of the present embodiment may be disposed in at least one of corner regions of the carrier 310. The first damper 320 may be fixedly disposed on the carrier 310 through a fixing member 310f included in the carrier 310.

In an example, the first damper 320 may have a shape in which one corner is cut off from a square, based on a cross-section perpendicular to an optical axis (Z-axis). The first damper 320 is configured considering the shape of the carrier 310 for disposing a lens barrel 210, and a region thereof cut from the first damper 320 may be formed in a corner region facing the lens barrel 210.

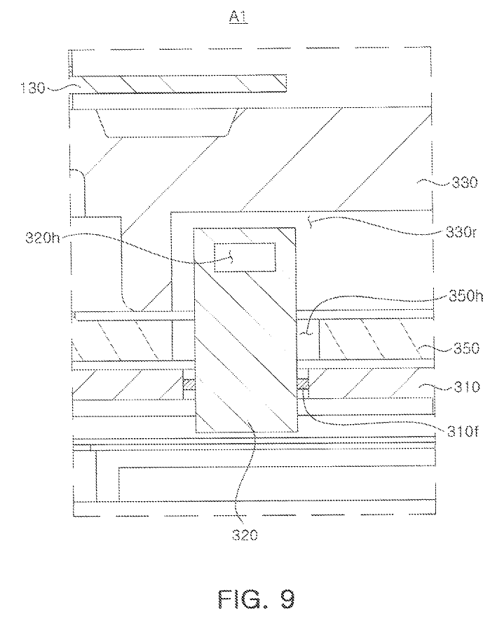

Hereinafter, with reference to FIGS. 9 to 13, embodiments in which a shape of a first damper 320 of the present embodiment or a position at which the first damper 320 is disposed in a carrier 310 are modified will be described.

FIGS. 9 to 11 are modified examples (A1, A2, A3) of the first damper 320 of FIG. 5.

Referring to FIG. 9, the first damper 320 according to the present modified example (A1) may include a second through-hole 320h. The second through-hole 320h may penetrate through the first damper 320 in a direction perpendicular to an optical axis (Z-axis). When the first damper 320 includes a second through-hole 320h, ductility of the first damper 320 in an optical axis (Z-axis) direction may be improved by a space of the second through-hole 320h. Accordingly, when a collision occurs between the first damper 320 and the first frame 330 in the optical axis (Z-axis) direction, a buffering effect may be further improved.

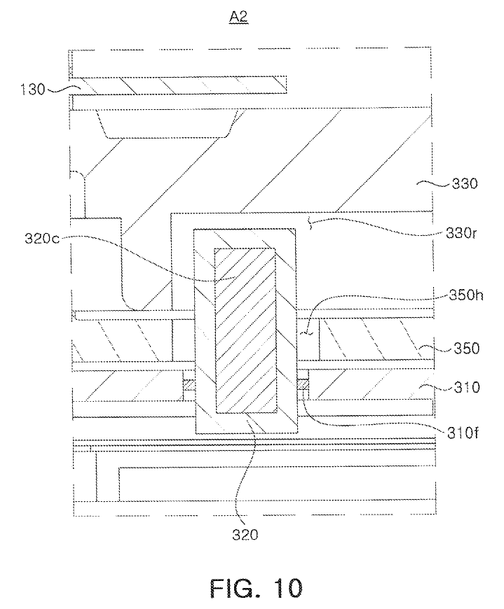

Referring to FIG. 10, the first damper 320 according to the present modified example A2 may include a core 320c therein. The core 320c may be a component having higher rigidity than that in the remaining region of the first damper 320. Preferably, the core 320c may be formed of a non-magnetic metal material. For example, the core 320c may include at least one of Al, Ti, Cu, Cu-Zn, and SUS, but an embodiment thereof is not limited.

When a core 320c is included inside the first damper 320, the rigidity of the entire first damper 320 increases, tilting of the first damper 320 between driving operations to perform autofocusing or optical imaging stabilization operations may be prevented, and when an external impact occurs, deformation of the position of the first damper 320 or a state in which it is fixed to the carrier 310 may be minimized.

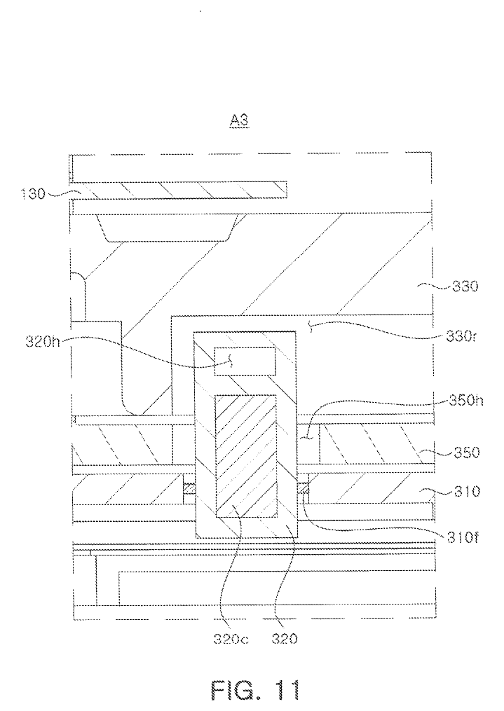

Referring to FIG. 11, the first damper 320 according to the present modified example A3 may include a second through-hole 320h and a core 320c. The second through-hole 320h may penetrate the first damper 320 in a direction perpendicular to the optical axis (Z axis). Additionally, a core 320c having a higher rigidity than the remaining region of the first damper 320 may be disposed below the second through-hole 320h.

Therefore, the first damper 320 of the present modified example may further improve a buffering effect when a collision occurs in the optical axis (Z-axis) direction with the first frame 330 by the second through-hole 320. The tilting of the first damper 320 between driving operations to perform autofocusing or optical imaging stabilization operations may be prevented by the core 320c included inside the first damper 320, and deformation of the position of the first damper 320 or a state in which it is fixed to the carrier 310 may be minimized when an external impact occurs.

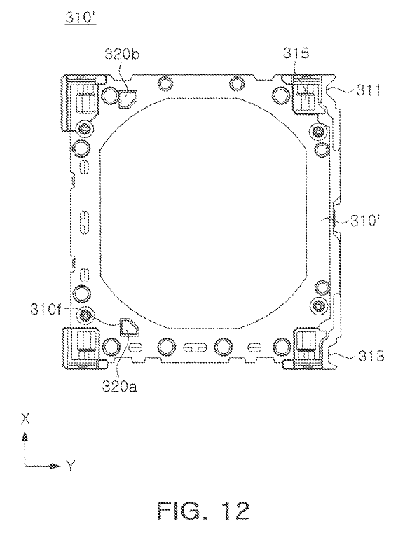

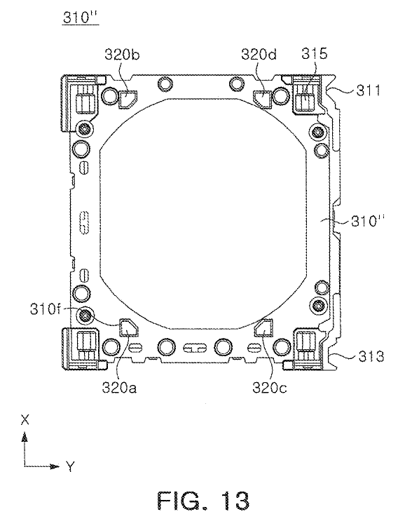

FIGS. 12 and 13 are modified examples 310' and 310” of the carrier 310 of FIG. 8.

Referring to FIGS. 12 and 13, a plurality of first dampers 320 may be disposed in a corner region of the carrier 310. Additionally, at least a pair of the plurality of first dampers 320 may be disposed in a direction perpendicular to an optical axis (Z-axis) (X-axis or Y-axis direction).

Referring to FIGS. 12 and 13, a plurality of first dampers 320 may be disposed in a corner region of the carrier 310. Additionally, at least a pair of the plurality of first dampers 320 may be disposed in a direction perpendicular to an optical axis (Z-axis) (X-axis or Y-axis direction). When a plurality of first dampers 320a and 320b are disposed as in the present modified example, an impact force may be dispersed, so that a buffering effect in an optical axis (Z-axis) direction or in a direction perpendicular to an optical axis (Z-axis) may be improved.

In the example of the carrier 310” illustrated in FIG. 13, four first dampers 320a, 320b, 320c, and 320d may be respectively disposed in corner regions thereof. When the first dampers 320a, 320b, 320c, and 320d are disposed at each corner of the carrier 310” as in the present modified example, a buffering effect in an optical axis (Z-axis) direction or in a direction perpendicular to the optical axis (Z-axis) may be further improved. Additionally, when the first damper 320 is in a buffering operation, an impact force may be appropriately distributed, and a buffering range may be widened. Additionally, the risk of tilting which occurs in the first frame 330 when buffering in the optical axis (Z-axis) direction may be minimized.

As set forth above, in accordance with the one or more embodiments, a size of a joint that may occur during a driving operation to perform an autofocusing operation or an optical imaging stabilization operation may be reduced.

In addition, in accordance with the one or more embodiments, a camera module may effectively alleviate impacts applied in an optical axis direction or in a direction perpendicular to an optical axis.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing;
a carrier, disposed in the housing, and configured to move in an optical axis direction with respect to the housing;
a first damper fixed to the carrier; and
a first frame, disposed in the carrier, and configured to move in a direction perpendicular to an optical axis with respect to the carrier, and having a concave portion formed on a surface that faces the carrier,
wherein the first damper protrudes toward the first frame in the optical axis direction, and
wherein at least a portion of the concave portion faces the first damper in the direction perpendicular to the optical axis.

2. The camera module of claim 1, further comprising:
a second frame disposed between the carrier and the first frame, and configured to move in the direction perpendicular to the optical axis,
wherein the second frame comprises a first through-hole through which the first damper penetrates.

3. The camera module of claim 1, wherein the first damper comprises a surface that faces the concave portion in the optical axis direction.

4. The camera module of claim 2, wherein, based on the optical axis direction,
a minimum gap between the first frame and the first damper is greater than a minimum gap between the first frame and the second frame.

5. The camera module of claim 2, wherein, based on the optical axis direction,
a minimum gap between the first frame and the first damper is greater than a minimum gap between the second frame and the carrier.

6. The camera module of claim 2, wherein, based on the optical axis direction,
a minimum gap between the first frame and the first damper is less than a sum of a minimum gap between the first frame and the second frame and a minimum gap between the second frame and the carrier.

7. The camera module of claim 2, wherein, based on the direction perpendicular to the optical axis,
a minimum gap between the first frame and the first damper is greater than or equal to a maximum movable distance of the first frame in the direction perpendicular to the optical axis, and
a minimum gap between the second frame and the first damper is greater than or equal to a maximum movable distance of the second frame in the direction perpendicular to the optical axis.

8. The camera module of claim 1, wherein the first damper comprises an elastic material.

9. The camera module of claim 8, wherein the first damper comprises a core therein.

10. The camera module of claim 9, wherein the core is formed of a non-magnetic metal material.

11. The camera module of claim 8, wherein the first damper comprises a second through-hole that penetrates in the direction perpendicular to the optical axis.

12. The camera module of claim 11, wherein the first damper comprises a core therein.

13. The camera module of claim 1, wherein the first damper is disposed in at least one of corner regions of the carrier.

14. The camera module of claim 13, wherein the first damper is provided in plural, and at least a pair of the plurality of first dampers are disposed in the direction perpendicular to the optical axis.

15. The camera module of claim 1, further comprising:
a stopper coupled to the carrier to cover the first frame; and
a case coupled to the housing to cover the stopper,
wherein the stopper comprises a second damper that faces the case in the optical axis direction.

16. A camera module, comprising:
a housing unit;
a carrier, accommodated in the housing unit, and having a first damper disposed therein;
a first frame accommodated in the carrier, and coupled to a lens barrel; and
a second frame disposed between the carrier and the first frame,
wherein the first damper penetrates the second frame and a portion of the first damper is accommodated in the first frame, and
wherein, based on an optical axis direction, a minimum gap between the first frame and the first damper is greater than a minimum gap between the first frame and the second frame and a minimum gap between the second frame and the carrier, respectively, and is less than a sum of the minimum gap between the first frame and the second frame and the minimum gap between the second frame and the carrier.

17. The camera module of claim 16, wherein the carrier comprises a first surface that faces the first frame and a second surface opposite to the first surface, and
wherein the first damper protrudes beyond the second surface of the carrier.

18. The camera module of claim 16, wherein the first damper is fixed to the carrier by a fixed member comprised in the carrier.
